(19) United States
(12) Patent Application Publication
(10) Pub. No.: US 2011/0093302 A1
(43) Pub. Date: Apr. 21, 2011

(54) SYSTEM FOR AND METHOD OF ORDERING FROM A CONCESSION DURING AN EVENT

(75) Inventor: Daniel HERNANDEZ, Cedar Rapids, IA (US)

(73) Assignee: VERIZON PATENT AND LICENSING, INC., Basking Ridge, NJ (US)

(21) Appl. No.: 12/582,258

(22) Filed: Oct. 20, 2009

(51) Int. Cl. G06Q 50/00; G06Q 10/00; G06Q 30/00; G06F 15/16

(52) U.S. Cl. 705/5; 705/15; 705/24; 709/206; 705/26.1

(57) ABSTRACT

A system for and method of ordering from a concession during an event is presented. The system and method may include receiving customer data associated with a customer during an event ticket purchase transaction, associating the customer data with customer seating data that indicates a location of the customer's seating during an event, providing menu data to a customer system that is associated with the customer, and receiving, from the customer system, order data that indicates a concession order from the customer via a network.

### BACKGROUND INFORMATION

In general, many concession stands at certain venues (e.g., stadiums, halls, theatres) that are hosting events (e.g., concert events, sporting events) may maintain long lines of customers desiring to purchase one or more items. Accordingly, these customers may spend an undesirable amount of time waiting for their turn to place an order. Such lengthy delays at concession states may make attending the event less enjoyable.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a concession delivery system according to a particular embodiment;

FIG. 2 is a block diagram of a hardware component of the concession order system of a particular embodiment;

FIG. 3 illustrates the appearance of a user interface according to a particular embodiment; and

FIG. 4 is a flowchart illustrating the functionality of a particular embodiment.

### DETAILED DESCRIPTION OF PREFERRED EMBODIMENTS

Traditionally, a customer at an event (e.g., a concert event, a sporting event, a theatrical event) may visit one or more concession stands to purchase one or more items during the event. For example, the customer may visit a first concession stand (e.g., a hotdog concession stand) to purchase one or more items (e.g., hotdogs) at a first time during the event. Subsequently, the customer may visit a second concession stand (e.g., a pizza concession stand) to purchase one or more items (e.g., pizza) at a second time during the event. At a later time, the customer may visit a third concession stand (e.g., a memorabilia concession stand) to purchase one or more items (e.g., t-shirts) at a third time during the event. Increases in the amount of time a customer spends visiting concession stands generally results in decreases in the amount of time the customer spends at a seat enjoying the event.

A concession delivery system that is communicatively coupled to one or more customer systems and one or more concession systems may be used to allow the delivery of one or more ordered items (e.g., concession items) to the customer at the customer's seat during an event. The concession delivery system may be configured to store customer data that includes customer identification information (e.g., a customer's mobile telephone number, a unique customer number), card payment information (e.g., credit card information, debit card information), or a combination of both, that is received during an event ticket purchase transaction. The concession delivery system may also be configured to store customer seating data that indicates a location of the customer's seating during an event that is generated during an event ticket purchase transaction.

During an event, a customer may access the concession delivery system to view one or more items for sale on one or more concession menus using a customer system. The customer may then initiate the transmission of order data (e.g., one or more concession orders) to the concession delivery system using one or more input devices (e.g., a touch screen, a key board) of the customer system. In one embodiment, the order data may be transmitted to the concession delivery system in a text message format. In another embodiment, the order data may be transmitted to the concession delivery system in an instant message format. In yet another embodiment, the order data may be transmitted to the concession delivery system in an email message format.

Based on the order data received, the concession delivery system may transmit the customer data, the customer seating data, and the order data to the appropriate concession system. The concession system may process the order data (e.g., fulfill the concession order) by initiating a purchase transaction that generates a sales receipt, transmitting the sales receipt to the concession delivery system, and generating one or more data signals that indicate that the concession order is ready for delivery to the customer's seating location.

In one embodiment, the concession delivery system may transmit the sales receipt to the customer system. In another embodiment, the sales receipt may be delivered to the customer by an employee of a concession stand associated with the concession system along with the concession order.

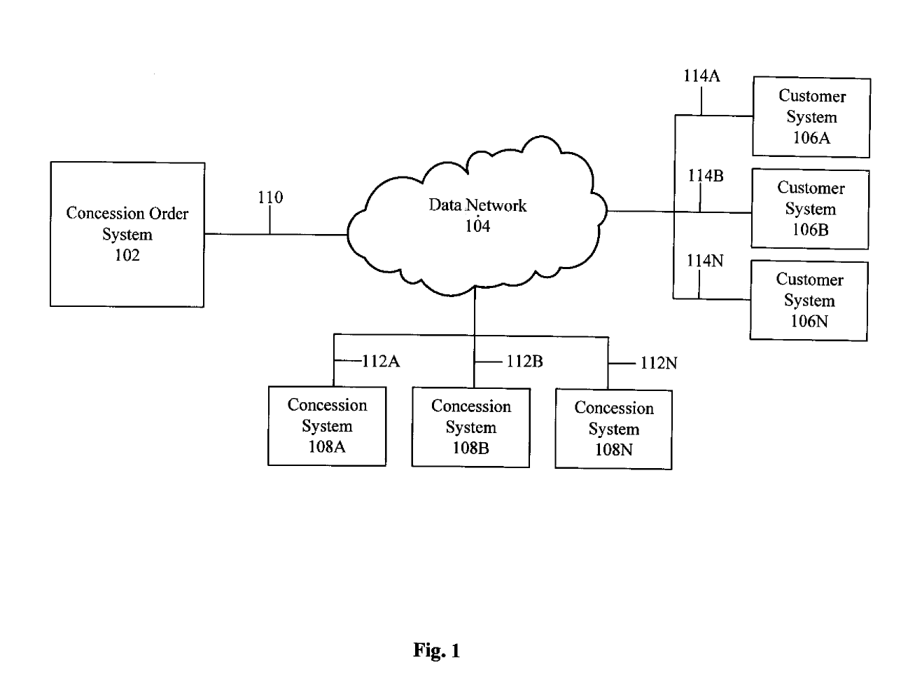

FIG. 1 is a schematic diagram illustrating a concession delivery system according to a particular embodiment. A concession delivery system may communicatively couple together any, or a combination, of a concession order system 102, customer systems 106A, 106B, 106N, and concession systems 108A, 108B, 108N using data network 104. Accordingly, data signals may be transmitted to any of the components of the concession delivery system and transmitted from any of the components of the concession delivery system using data network 104. For example, customer data signals, customer seating data signals, menu data signals, order data signals, or sales receipt data signals may be transmitted to any of the components of the concession delivery system and transmitted from any of the components of the concession delivery system using data network 104.

Data network 104 may be a wireless network, a wired network or any combination of wireless network and wired network. For example, data network 104 may include one or more of a fiber optics network, a passive optical network, a cable network, an Internet network, a satellite network (e.g., operating in Band C, Band Ku, or Band Ka), a wireless local area network (LAN), a Global System for Mobile Communication (GSM), a Personal Communication Service (PCS), a Personal Area Network (PAN), D-AMPS, Wi-Fi, Fixed Wireless Data, IEEE 802.11a, 802.11b, 802.15.1, 802.11n and 802.11g or any other wired or wireless network for transmitting and/or receiving a data signal. In addition, data network 104 may include, without limitation, a telephone line, fiber optics, IEEE Ethernet 802.3, a wide area network (WAN), a LAN, or a global network, such as the Internet. Also, data network 104 may support, an Internet network, a wireless communication network, a cellular network, or the like, or any combination thereof. Data network 104 may further include one or any number of the exemplary types of networks mentioned above operating as a stand-alone network or in cooperation with each other. Data network 104 may utilize one or more protocols of one or more network elements to which it is communicatively coupled. Data network 104 may translate to or from other protocols to one or more protocols of network devices. Although data network 104 is depicted as one network, it should be appreciated that according to one or more embodiments, data network 104 may comprise a plurality of interconnected networks, such as, for example, a service provider network, the Internet, a broadcaster's network, a cable television network, corporate networks, and home networks.

Concession order system 102, concession systems 108A, 108B, 108N, and customer systems 106A, 106B, 106N may transmit data to and receive data from data network 104 representing customer data, customer seating data, menu data, order data, sales receipt data, and other data. The data may be transmitted and received utilizing a standard telecommunications protocol or a standard networking protocol. For example, one embodiment may utilize Session Initiation Protocol (SIP). In other embodiments, the data may be transmitted, received, or a combination of both, utilizing other VoIP or messaging protocols. For example, data may also be transmitted, received, or a combination of both, using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and systems suitable for transmitting and receiving data. Data may be transmitted and received wirelessly or may utilize cabled network or telecom connections such as: an Ethernet RJ45/Category 5 Ethernet connection, a fiber connection, a traditional phone wire-line connection, a cable connection, or other wired network connection. Data network 104 may use standard wireless protocols including IEEE 802.11a, 802.11b and 802.11g. Data network 104 may also use protocols for a wired connection, such as an IEEE Ethernet 802.3.

Customer systems 106A, 106B, 106N may be communicatively coupled to data network 104 via data paths 114A, 114B, 114N, respectively. Customer systems 106A, 106B, 106N may include, but are not limited to, a computer device or communications device including, e.g., a personal computer (PC), a personal digital assistant (PDA), a mobile device, a handheld PC, a network appliance, an Internet browser, a mobile telephone, a smart phone, or any other devices that are configured to transmit customer data and order data via data paths 114A, 114B, 114N, receive menu data and sales receipt data via data paths 114A, 114B, 114N, and display menu data via communicatively coupled display devices (e.g., LCD screens).

Concession systems 108A, 108B, 108N may be communicatively coupled to data network 104 via data paths 112A, 112B, 112N, respectively. Concession systems 108A, 108B, 108N may include, but are not limited to, a personal computer (PC), a workstation, a mobile device, a handheld PC, a thin system, a fat system, a network appliance, an Internet browser, a server, a lap top device, a VoIP device, an ATA, a video server, a Public Switched Telephone Network (PSTN) gateway, a Mobile Switching Center (MSC) gateway, or any other devices that are configured to receive customer data, customer seating data, and order data via data paths 112A, 112B, 112N, transmit sales receipt data via data paths 112A, 112B, 112N, process order data (e.g., initiate a purchase transaction), and generate one or more data signals that indicate that a concession order is ready for delivery to the customer's seating location.

In one embodiment, the concession systems 108A, 108B, 108N may include software, hardware, or a combination of both, configured to print out a sales receipt such that the sales receipt is available to be delivered to the customer by an employee of a concession stand associated with a concession system along with a concession order.

Concession order system 102 may be communicatively coupled to data network 104 via data path 110. The concession order system 102 may include, but is not limited to, a computer device or communications device including, e.g., a personal computer (PC), a workstation, a mobile device, a handheld PC, a thin system, a fat system, a network appliance, an Internet browser, a server, a lap top device, a set top box, a VoIP device, an ATA, a video server, a Public Switched Telephone Network (PSTN) gateway, a Mobile Switching Center (MSC) gateway, or any other device that is configured to receive (and store) customer data, order data, and sales receipt data via data path 110, transmit (and store) menu data, order data, customer data, customer seating data, and sales receipt data via data path 110, and generate customer seating data. Details of the concession order system 102 are provided below.

One or more data paths disclosed herein may include any device that communicatively couples one or more devices to each other. For example, one or more data paths may include one or more networks (e.g., wireless, LAN, PON) or one or more conductive wires (e.g., copper wires).

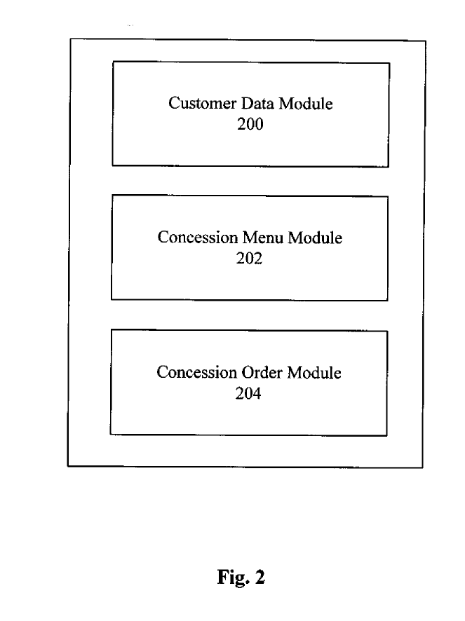

FIG. 2 is a block diagram of a hardware component of the concession order system of a particular embodiment. The concession order system 102 may include a customer data module 200, a concession menu module 202, and a concession order module 204. It is noted that the modules 200, 202, and 204 are exemplary. The functions of the modules 200, 202, and 204, may be performed at other modules remote or local to the concession order system 102, and the modules 200, 202, and 204 may be combined or separated.

The customer data module 200 may include software, hardware, or a combination of both, configured to receive customer data associated with a customer during an event ticket purchase transaction. An event ticket purchase transaction may include any data exchange between a ticket supplier (or an agent of a ticket supplier) and a customer that allows the purchase of one or more event tickets at a particular price. Customer data may include customer identification information (e.g., a customer's mobile telephone number, a unique customer number), card payment information (e.g., a customer's credit card information, a customer's debit card information), or a combination of both.

For example, the customer data module 200 may be configured to receive customer data in the form of a first mobile telephone number (e.g., 555-555-5555) and first credit card information (e.g., Visa credit card # 1234 5678 0000 2222 with an expiration date of 12/2011) from a first customer (e.g., John Doe) during the purchase of a set of first event tickets (e.g., a set of tickets to attend a New York Giants football game at a stadium). In another example, the customer data module 200 may be configured to receive customer data in the form of a second mobile telephone number (e.g., 555-123-4567) and debit card information (e.g., Visa debit card # 1111 2222 3333 4444 with an expiration date of 9/2010) from a second customer (e.g., Jane Doe) during the purchase of a set of second event tickets (e.g., a set of tickets to attend a Broadway play at a theatre). In yet another example, the customer data module 200 may be configured to receive customer data in the form of a unique customer number (e.g., 3125976854) and second credit card information (e.g., MasterCard credit card # 9999 8888 7777 6666 with an expiration date of 6/2014) from a third customer (e.g., John Smith) during the purchase of a set of third event tickets (e.g., a set of tickets to attend a Washington Nationals baseball game at a stadium).

The customer data module 200 may be configured to store customer seating data that is generated during the event ticket purchase transaction and indicates a location of a customer's seating during an event. The customer data module 200 may also be configured to associate customer seating data generated during a particular event ticket purchase transaction with customer data received during the same event ticket purchase transaction. Accordingly, the customer data module 200 may include one or more databases that store indexed entries of customer data and associated customer seating data.

The concession menu module 202 may include software, hardware, or a combination of both, configured to store menu data. Menu data may include data that indicates one or more items for sale on one or more concession menus. In one embodiment, the concession menu module 202 may store one or more concession menus associated with one or more concession stands at a particular venue (e.g., a particular stadium, a particular arena, a particular theatre). For example, the concession menu module 202 may store menu data associated with a first concession stand (e.g., Bob's Hot Dogs concession stand) operating at a venue (e.g., FedEx Field stadium that is home to the Washington Redskins football team). In another example, the concession menu module 202 may store menu data associated with a second concession stand (e.g., Ray's Pretzels concession stand) operating at the venue. In yet another example, the concession menu module 202 may store menu data associated with a third concession stand (e.g., Pete's Sporting Goods concession stand) operating at the venue.

The concession menu module 202 may be configured to transmit appropriate menu data to one or more customer systems (associated with one or more customers) using the customer data, customer seating data, or a combination of both. Based on the customer seating data that indicates the a location of a customer's seating during a particular event, the concession menu module 202 locate and transmit menu data that is associated with one or more concession stands that are operating at the particular event a customer is attending.

In one embodiment, the concession menu module 202 may be configured to transmit appropriate menu data to one or more customer system in response to a request from the one or more customer systems. In such embodiments, the concession menu module 202 may use location data that is associated with the request data and that indicates an approximate location of the customer to determine the appropriate menu data to transmit (e.g., menu data that is associated with one or more concession stands operating at the customer's approximate location).

The concession order module 204 may include software, hardware, or a combination of both, configured to receive order data from one or more customer systems. Order data may include data that indicates a customer's concession order. In one embodiment, the concession order module 204 may receive the order data in a text message format (e.g., in a text message sent from a customer system). In another embodiment, the concession order module 204 may receive the order data in an instant message format (e.g., in an instant message sent from a customer system). In yet another embodiment, the concession order module 204 may receive the order data in an email message format (e.g., in an email message sent from a customer system).

Based on the order data received, the concession order module 204 may locate and retrieve customer data and customer seating data associated with the order data. Subsequently, the concession order module 204 may transmit the customer data, the customer seating data, and the order data to the appropriate concession system (e.g., the concession system associated with the concession stand from which the customer selected items to be included in a concession order) based on the order data.

After a concession system processes the order data, the concession order module 204 may receive a sales receipt associated with the purchase of one or more items in a concession order from the concession system. The concession order module 204 may then transmit the sales receipt (e.g., sales receipt data) to the customer system associated with the customer that placed the concession order.

The concession system of a concession stand may output one or more data signals that indicate that a concession order is ready for delivery to the customer's seating location (e.g., an “order ready” indicator). After observing an indicator, an employee of the concession stand may deliver the concession order to the appropriate customer using the customer seating data provided by the concession order module 204. Alternately, a customer system may be provided with an estimated time upon which a concession order will be ready. The customer may then pick up the concession order from the appropriate concession stand.

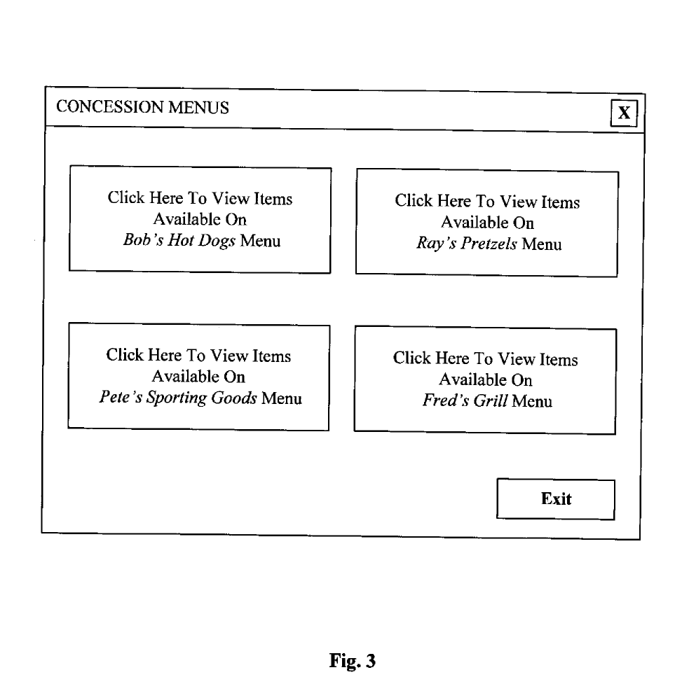

FIG. 3 illustrates the appearance of a user interface according to a particular embodiment. As illustrated, a customer may access a concession menus interface that allows the customer to access one or more concession menus using a customer system. Accordingly, the customer activate one or more hyperlinks using an input device of the customer system to access and view one or more concession menus.

For example, a concession menus interface may display a “Click Here To View Items Available On Bob's Hot Dogs Menu” hyperlink. In another example, a concession menus interface may display a “Click Here To View Items Available On Ray's Pretzels Menu” hyperlink. In yet another example, a concessions menus interface may display a “Click Here To View Items Available On Pete's Sporting Goods Menu” hyperlink. In yet another example, a concessions menus interface may display a “Click Here To View Items Available On Fred's Grill Menu” hyperlink. Using an input device, the customer may select a menu and view one or more items available on a particular concession menu. The customer may also submit a concession order to the concession order system 102 using a customer system.

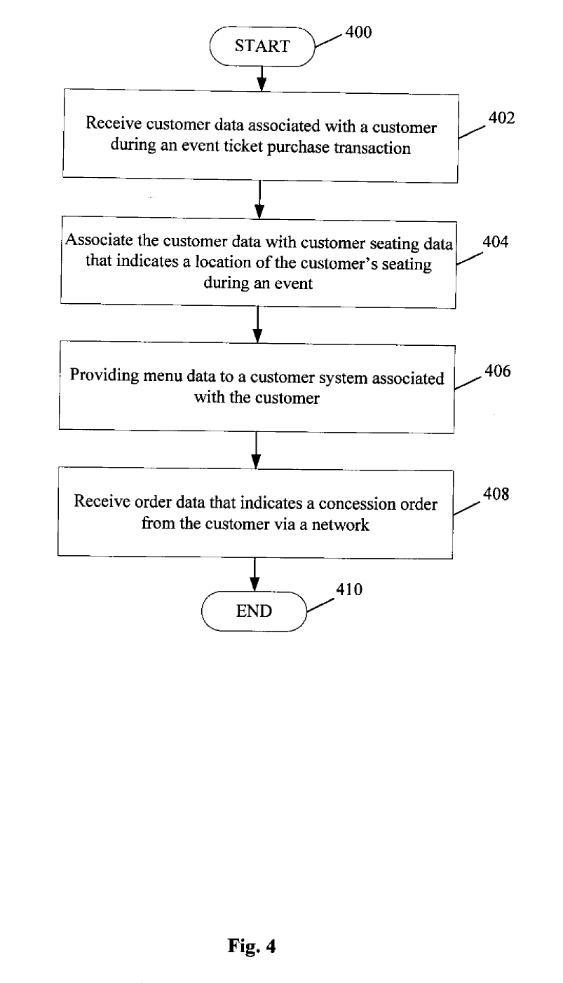

FIG. 4 is a flowchart illustrating the functionality of a particular embodiment. This exemplary method is provided by way of example, as there are a variety of ways to carry out methods disclosed herein. The method shown in FIG. 4 may be executed or otherwise performed by one or a combination of various systems. The method is described below as carried out by the concession order system 102 shown in FIG. 1 by way of example, and various elements of the concession order system 102 are referenced in explaining the example method of FIG. 4. Each block shown represents one or more processes, methods, or subroutines carried out in the exemplary method. Referring to FIG. 4, the exemplary method may begin at block 400.

In block 402, the method may include receiving customer data associated with a customer during an event ticket purchase transaction. In one embodiment, the customer data module 200 of the concession order system 102 may receive customer data associated with a customer during an event ticket purchase transaction. The method may continue to block 404.

In block 404, the method may include associating the customer data with customer seating data that indicates a location of the customer's seating during an event. In one embodiment, the customer data module 200 of the concession order system 102 may associate the customer data with customer seating data that indicates a location of the customer's seating during an event. The method may continue to block 406.

In block 406, the method may include providing menu data to a customer system that is associated with the customer. In one embodiment, the concession men module 202 of the concession order system 102 may provide menu data to a customer system that is associated with the customer. The method may continue to block 408.

In block 408, the method may include receiving order data that indicates a concession order from the customer via a network. In one embodiment, the concession order module 204 of the concession order system 102 may receive order data that indicates a concession order from the customer via a network. The method may then end at block 410.

In one embodiment, one or more customers may use a customer system to call a concession order system to place a concession order. In such embodiments, a concession order system be configured to identify a particular customer using caller ID data that would allow the system to detect the mobile telephone number of the customer. In one embodiment, calls or messages transmitted to the concession order system may be routed based on event data that indicates the time of a particular event. If, for example, a customer calls or messages the concession order system during an event, the concession order system may route the call or message to one or more systems configured to receive a concession order. If, however, a customer calls or messages the concession order system during a time when an event is not taking place, the concession order system may route the call or message to one or more systems configured to enable event ticket purchase transactions.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system, comprising:
a customer data module configured to receive customer data associated with a customer during an event ticket purchase transaction and associate the customer data with customer seating data that indicates a location of the customer's seating during an event;
a concession menu module configured to provide menu data to a customer system that is associated with the customer; and
a concession order module configured to receive, from the customer system, order data that indicates a concession order from the customer via a network.

2. The system of claim 1, wherein the customer data comprises at least one of customer identification information and card payment information.

3. The system of claim 1, wherein the concession menu module is further configured to provide menu data to the customer system by providing menu data to the customer system in response to a request for menu data from the customer system.

4. The system of claim 1, wherein the menu data indicates one or more items for sale on one or more concession menus.

5. The system of claim 1, wherein the concession order module is further configured to receive order in at least one of a text message format, an instant message format, and an email message format.

6. The system of claim 2, wherein the concession order module is further configured to transmit, to a concession system, at least one of customer data, customer seating data, and order data via the network.

7. The system of claim 6, wherein the concession order module is further configured to receive, from the concession system, a sales receipt associated with the concession order.

8. The system of claim 7, wherein the concession order module is further configured to output, to the customer system, the sales receipt associated with the concession order.

9. The system of claim 7, wherein the sales receipt is associated with one or more items purchased by the customer and delivered to the customer at the location of the customer's seating.

10. The system of claim 1, wherein the network comprises a wireless network.

11. A method, comprising:
receiving customer data associated with a customer during an event ticket purchase transaction;
associating the customer data with customer seating data that indicates a location of the customer's seating during an event;
providing menu data to a customer system that is associated with the customer; and
receiving, from the customer system, order data that indicates a concession order from the customer via a network.

12. The method of claim 11, wherein the customer data comprises at least one of customer identification information and card payment information.

13. The method of claim 11, wherein providing menu data to the customer system further comprises providing menu data to the customer system in response to a request for menu data from the customer system.

14. The method of claim 11, wherein the menu data indicates one or more items for sale on one or more concession menus.

15. The method of claim 11, wherein receiving order data further comprises receiving order data in at least one of a text message format, an instant message format, and an email message format.

16. The method of claim 11, further comprising transmitting, to a concession system, at least one of customer data, customer seating data, and order data via the network.

17. The method of claim 16, further comprising receiving, from the concession system, a sales receipt associated with the concession order.

18. The method of claim 17, further comprising outputting, to the customer system, the sales receipt associated with the concession order.

19. The method of claim 17, wherein the sales receipt is associated with one or more items purchased by the customer and delivered to the customer at the location of the customer's seating.

20. The method of claim 11, wherein the network comprises a wireless network.

21. A computer readable media comprising code to perform the acts of the method of claim 11.
